(19) United States
(12) Patent Application Publication
(10) Pub. No.: US 2007/0143433 A1
(43) Pub. Date: Jun. 21, 2007

(54) Using statistical tracking information of instant messaging users

(76) Inventor: Brian K. Daigle, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/304,287

(22) Filed: Dec. 15, 2005

(51) Int. Cl. G06F 15/16

(52) U.S. Cl. 709/207

(57) ABSTRACT

Embodiments discussed in this disclosure provide for determining the presence of a user on a first client device. Embodiments of a method include receiving data related to instant messaging activity of the user, storing the data related to the instant messaging activity of the user, and creating at least one data log, the at least one data log including data related to the instant messaging activity of the user. Other embodiments are also provided.

### BACKGROUND

With the advent of the Internet, different forms of digital communications have recently appeared. Examples of such digital communications include email and instant messaging (IM). Often, in instant messaging, one user communicates with another user in near real time. Unlike email messages, which resides on a server or a client until deleted, IM messages typically vanish when an IM chat session is terminated, unless that instant messaging chat session is recorded in an instant messaging chat transcript.

Currently, techniques exist in instant messaging (IM) to provide a user with presence information related to a user's contacts (e.g., other parties that communicate with the user). Generally speaking, the user manually designates the presence information displayed to contacts. If a user desires not to be reached, the user can designate that the “busy” presence information is conveyed to the user's contacts. Additionally, the user's instant messaging software can generally provide an “away” presence indication to a user's contacts when the user's machine has received no inputs (e.g., keyboard or mouse activity) after a predetermined time period. Further, if the user is not logged onto the instant messaging server, an “inactive” presence indication can be communicated to the user's contacts.

While this presence indication can be useful to a user and his or her contacts, the current presence indication can be burdensome to use, and generally provides little to no substantive information regarding the user's actual presence. Additionally, depending on the settings of a particular user's instant messaging software, the user's presence information that is displayed to a contact can be inaccurate and thus less valuable.

Thus, a heretofore-unaddressed need exists in the industry to address the aforementioned deficiencies and inadequacies.

### SUMMARY

Embodiments of the present disclosure include a method for determining the presence of a user on a first client device. Embodiments of the method include receiving data related to instant messaging activity of the user and storing the data related to the instant messaging activity of the user. Other embodiments of the method include creating at least one data log, the at least one data log including data related to the instant messaging activity of the user.

Additionally, the present disclosure discusses a computer readable medium having a program for determining the presence of a user, where the user is associated with a first client device. The program includes logic configured to receive data related to instant messaging activity of the user and logic configured to store the data related to the instant messaging activity of the user. Other embodiments of the program include logic configured to create at least one data log, the at least one data log including data related to the instant messaging activity of the user.

Other systems, methods, features, and advantages of this disclosure will be or become apparent to one with skill in the art upon examination of the following drawings and detailed description. It is intended that all such additional systems, methods, features, and advantages be included within this description, be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

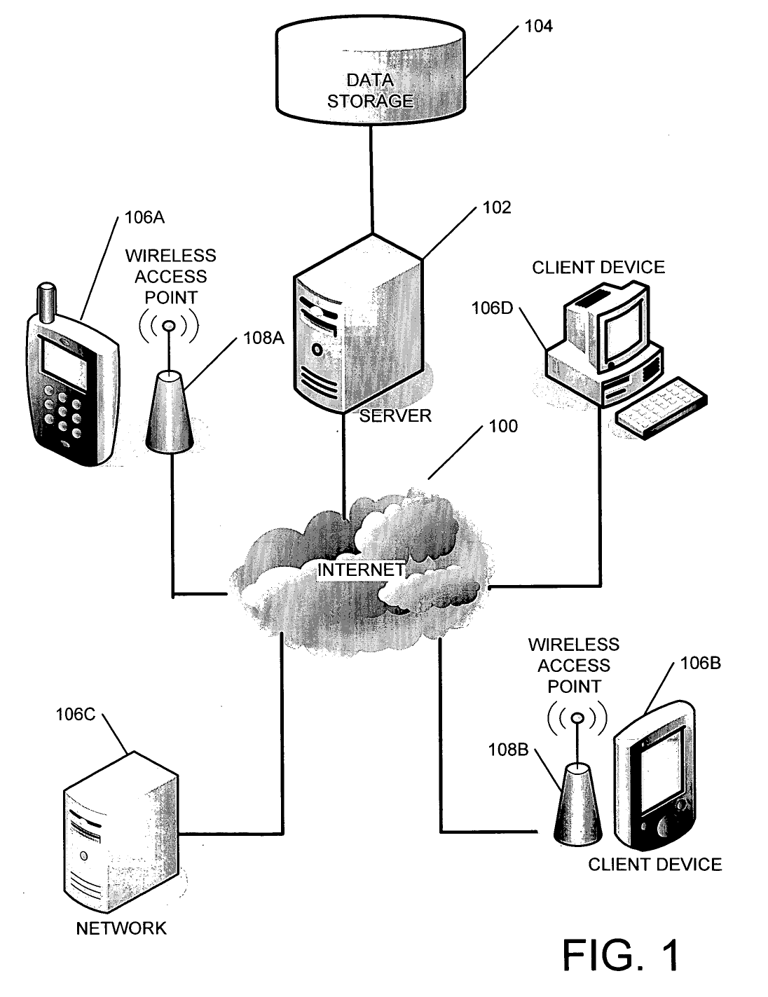

FIG. 1 is a functional diagram of an exemplary instant messaging network environment.

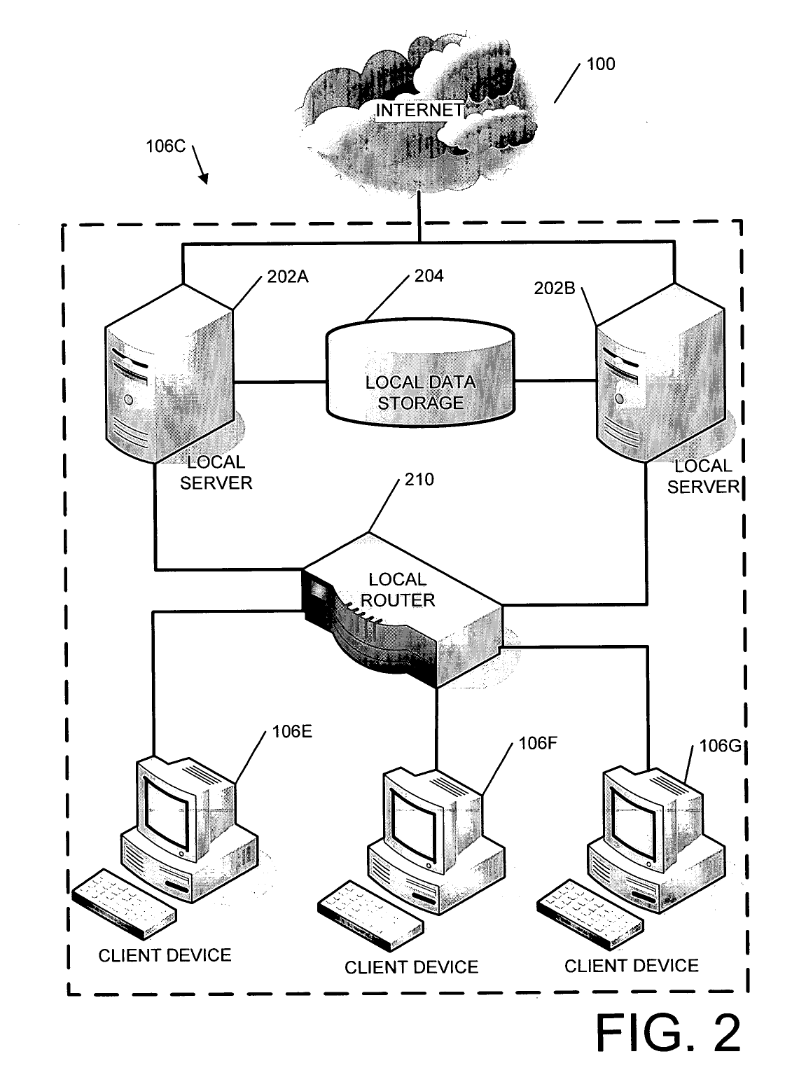

FIG. 2 is a functional diagram of an exemplary local network environment by which a user can send an instant message, similar to the environment from FIG. 1.

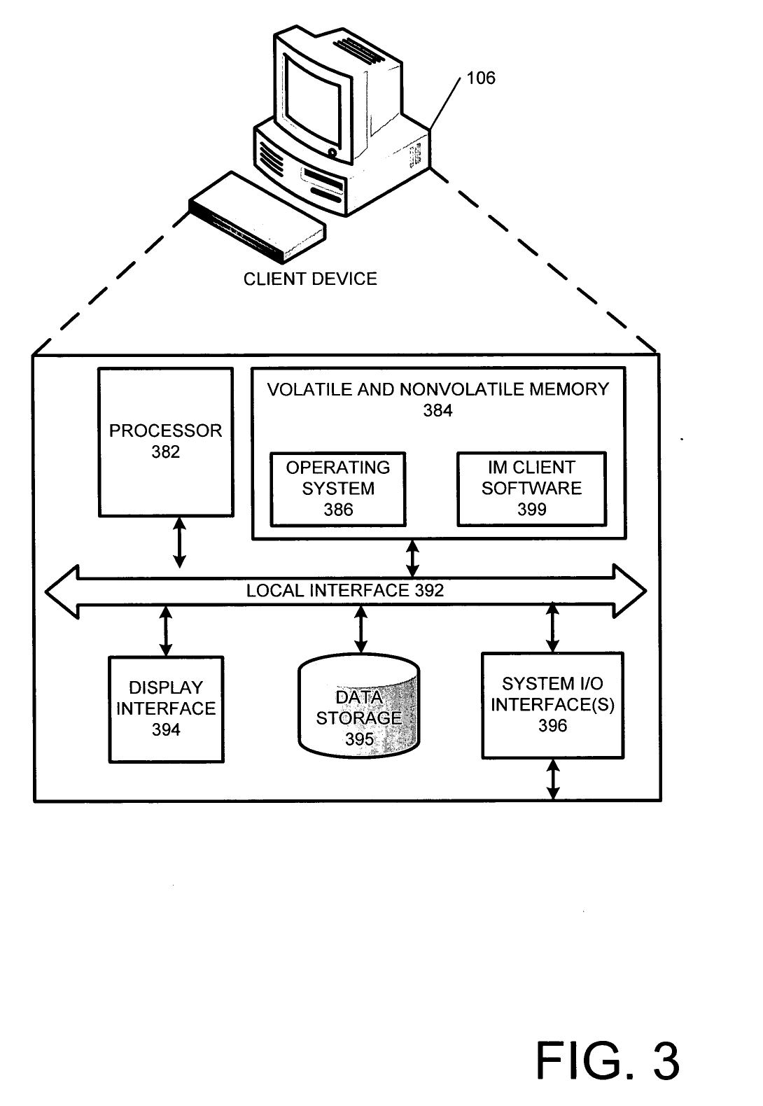

FIG. 3 is a functional diagram illustrating an exemplary embodiment of a client device that may be configured to communicate via a communications network, such as the networks from FIGS. 1 and 2.

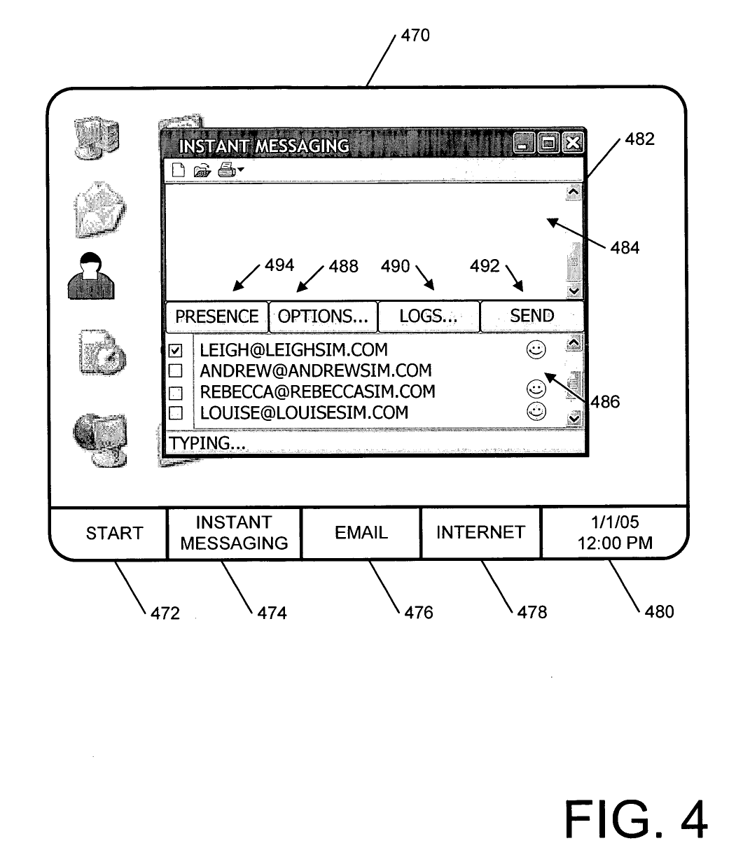

FIG. 4 is an illustration of an exemplary display for the instant messaging client software discussed with reference to FIGS. 1 and 2.

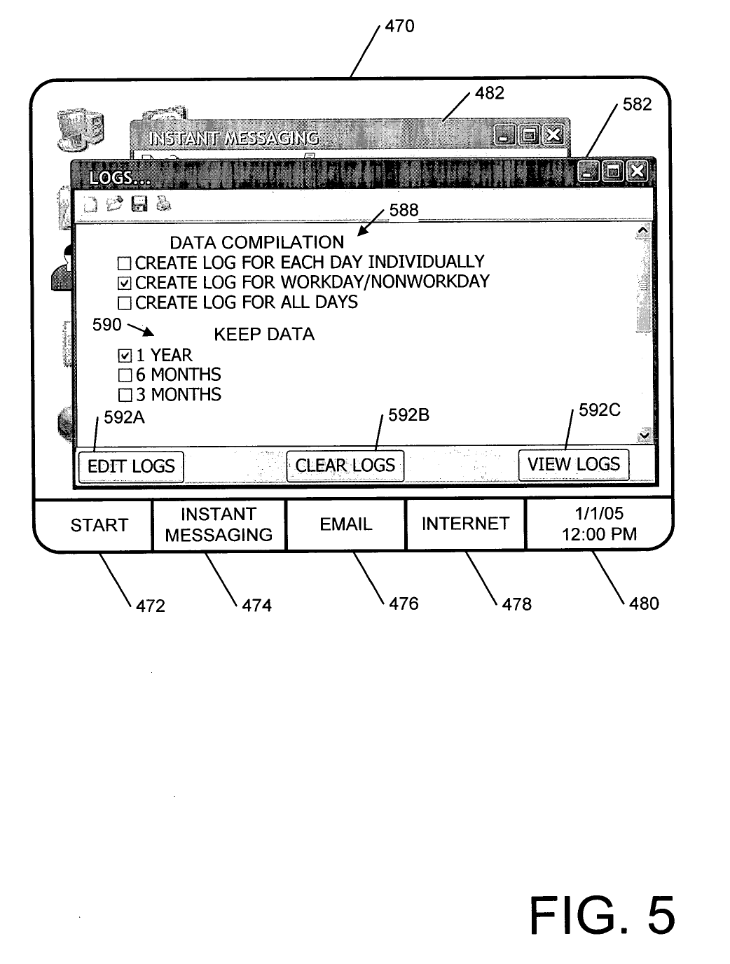

FIG. 5 is an illustration of an exemplary display for the instant messaging client software that can be displayed in response to selecting an option from FIG. 4.

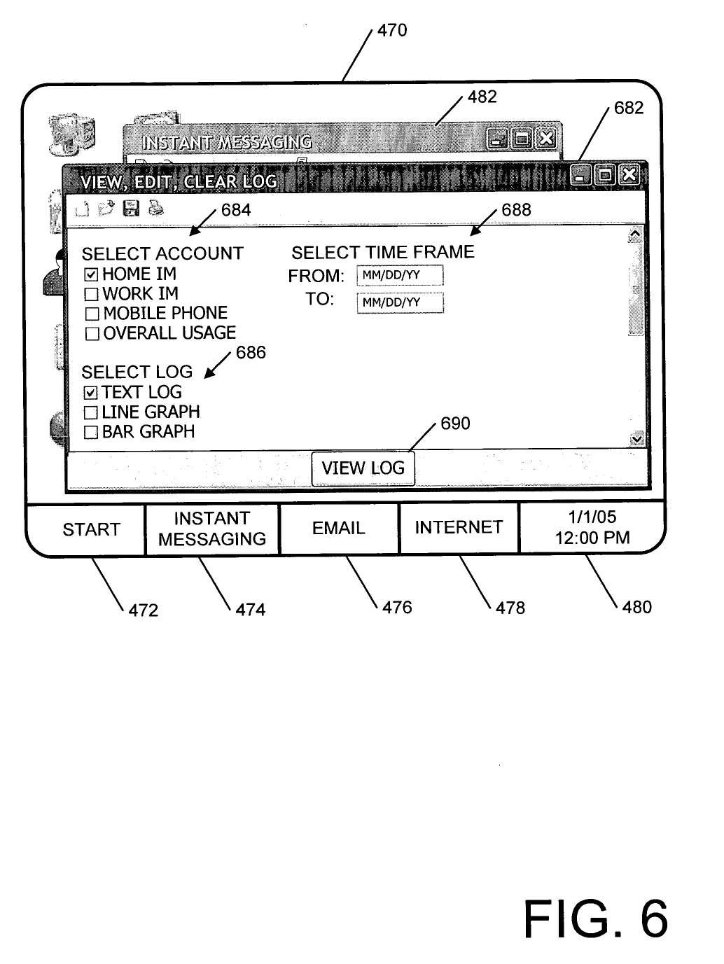

FIG. 6 is an illustration of an exemplary display for the instant messaging client software that can be displayed in response to selecting an option from FIG. 5.

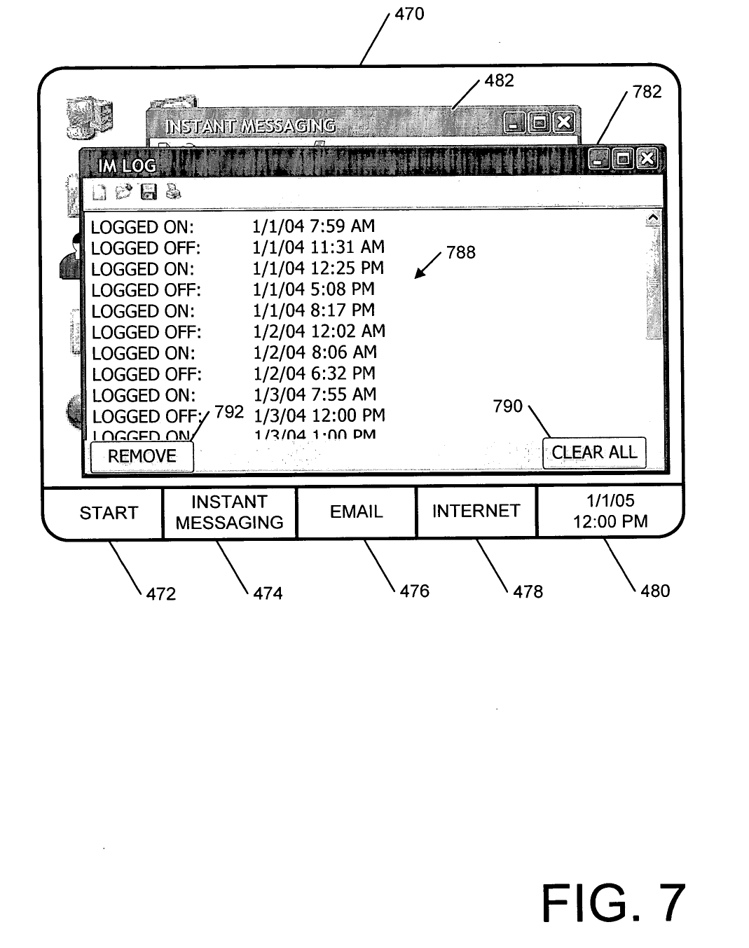

FIG. 7 is an illustration of an exemplary display for the instant messaging client software that can be displayed in response to selecting the view logs option from FIG. 6.

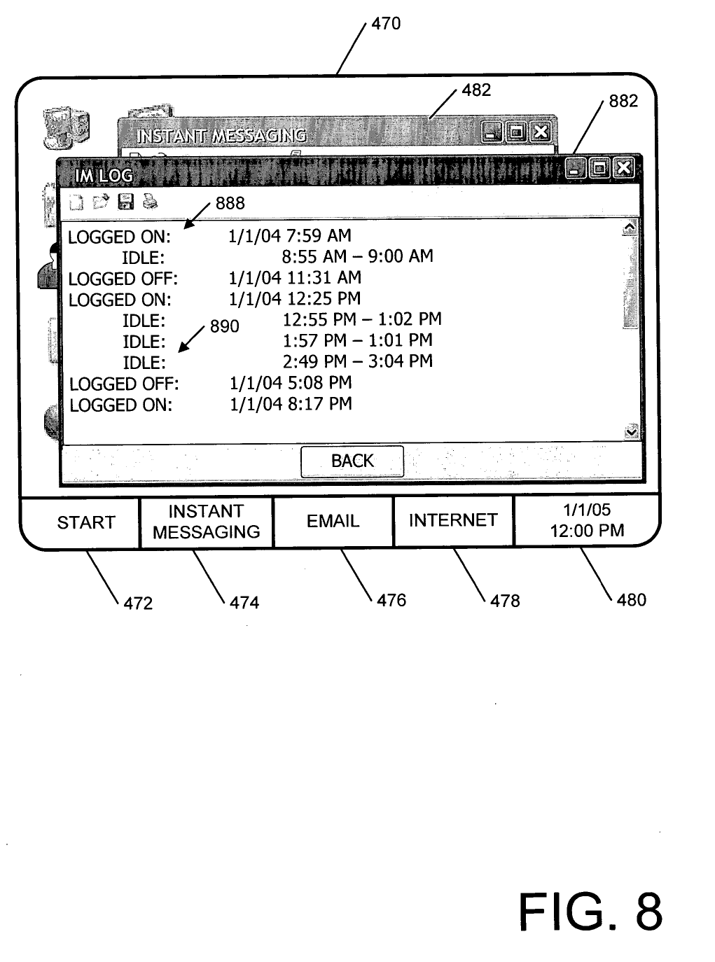

FIG. 8 is an illustration of an exemplary display for the instant messaging client software that can be displayed in response to selecting the view logs option from FIG. 6.

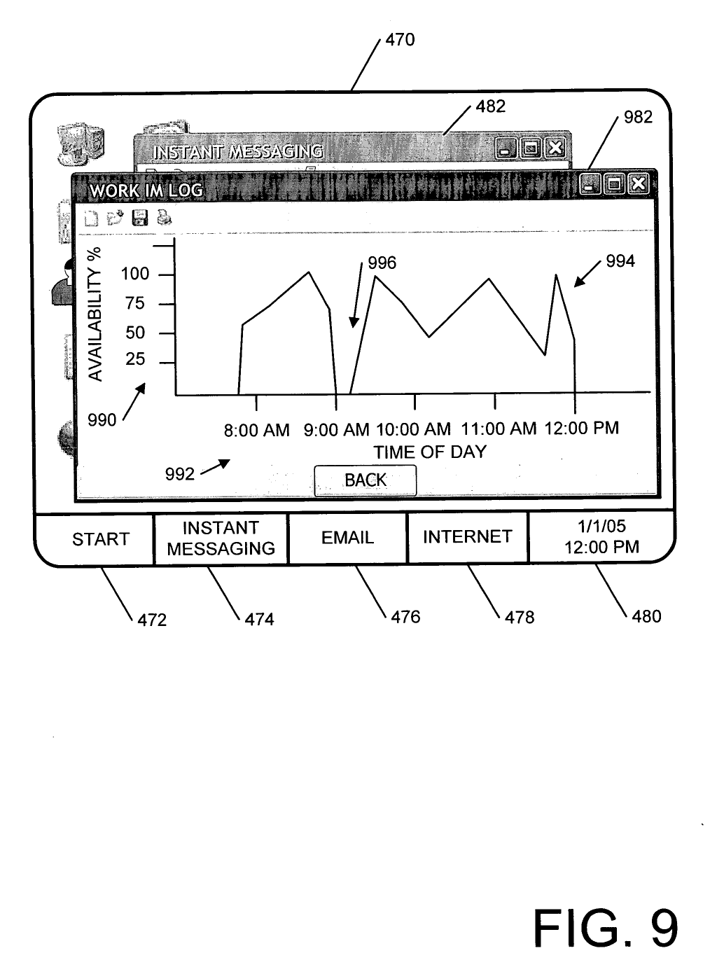

FIG. 9 is an illustration of an exemplary display for the instant messaging client software that can be displayed in response to selecting the view logs option from FIG. 6.

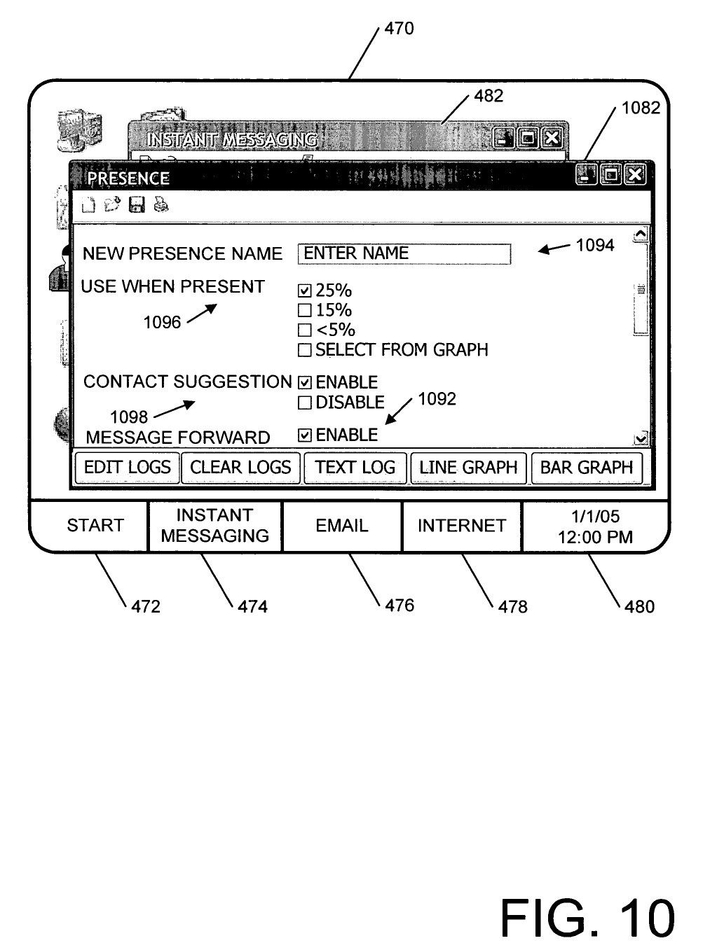

FIG. 10 is an illustration of an exemplary display for the instant messaging client software that can be displayed in response to selecting the presence option from FIG. 5.

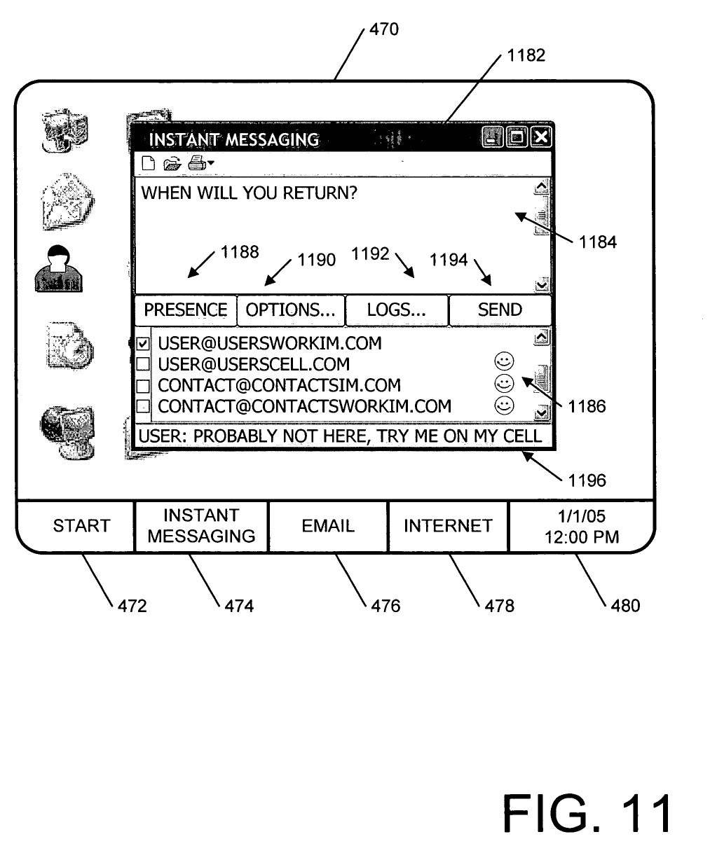

FIG. 11 is an illustration of an exemplary display for the instant messaging client software that can be displayed to a contact in an instant messaging environment, such as the instant messaging environments of FIGS. 1 and 2.

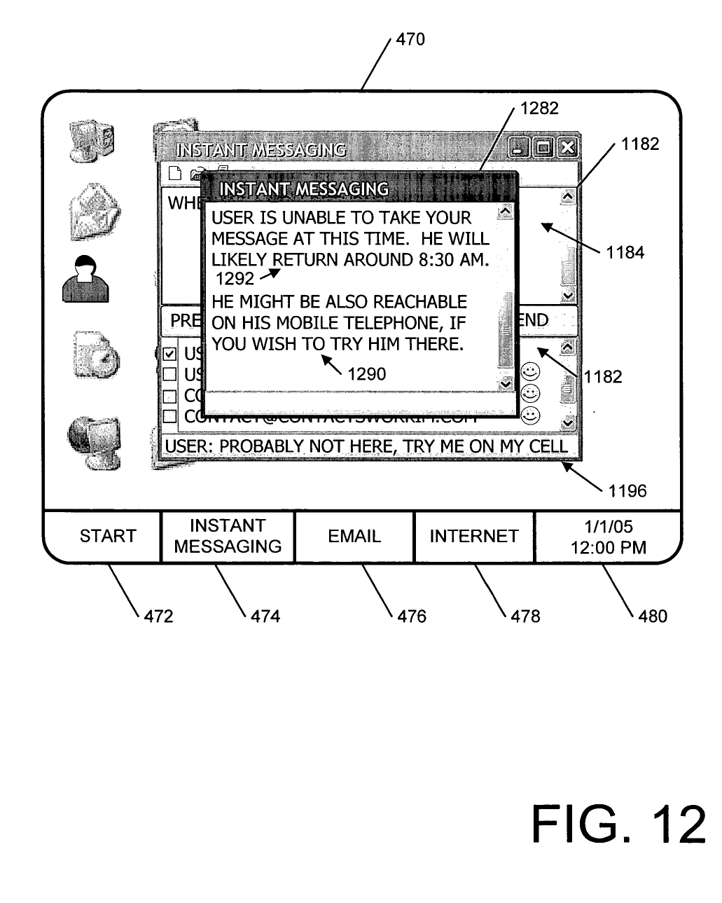

FIG. 12 is an illustration of an exemplary display for the instant messaging client software that can be displayed to a contact in response to sending an instant message to a user, as discussed with reference to FIG. 11.

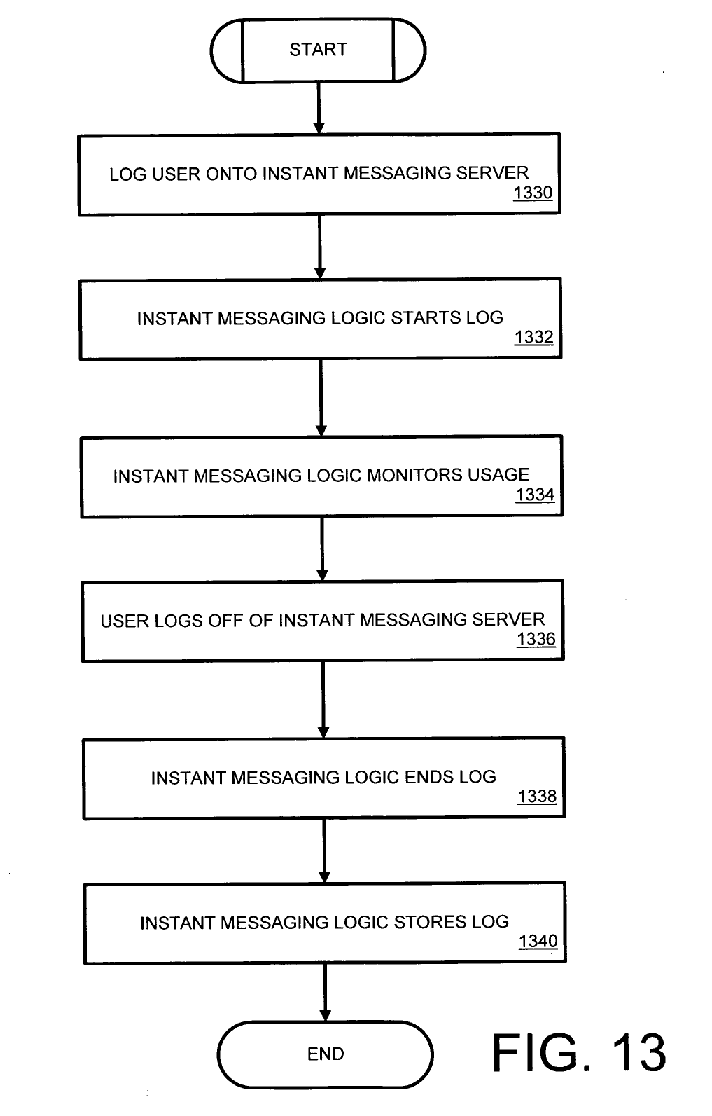

FIG. 13 is a flowchart illustrating exemplary steps for creating a log, such as the instant messaging usage log from FIG. 8.

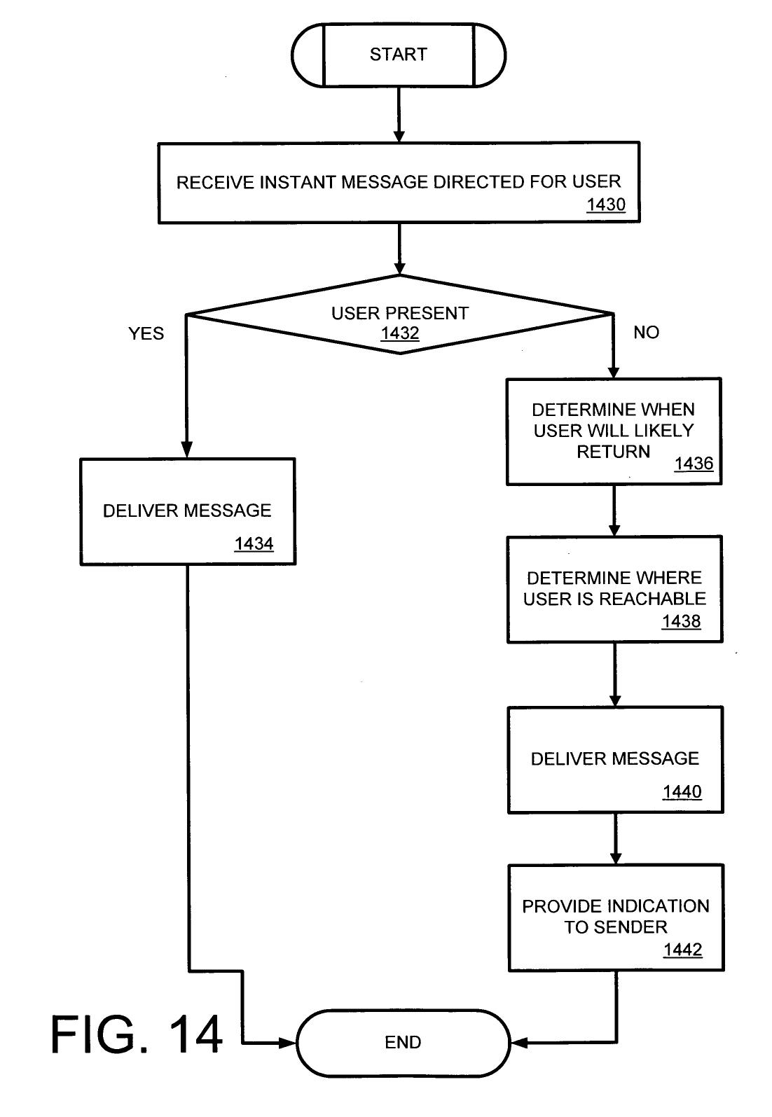

FIG. 14 is a flowchart illustrating exemplary steps that can be performed by a server in applying a data log, such as the data log from FIG. 8.

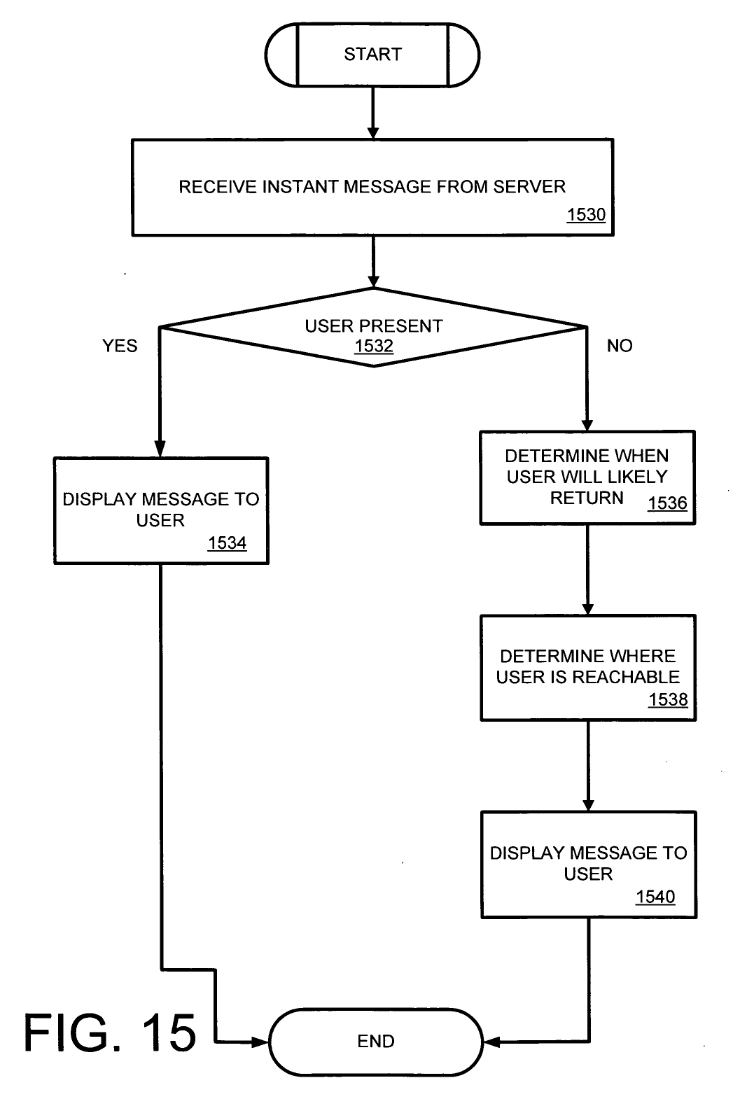

FIG. 15 is a flowchart illustrating exemplary steps that can be performed by client logic in applying a data log, such as the data log from FIG. 8.

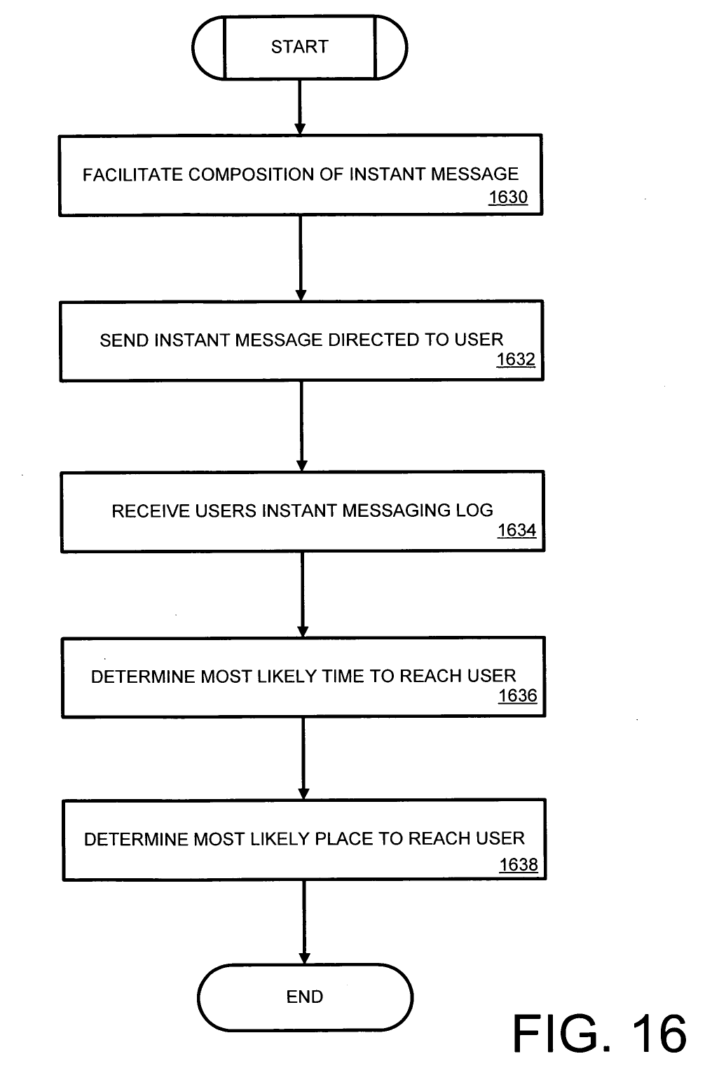

FIG. 16 is a flowchart illustrating exemplary steps that a message sender's instant messaging client software can perform when sending a message, as shown in FIG. 11.

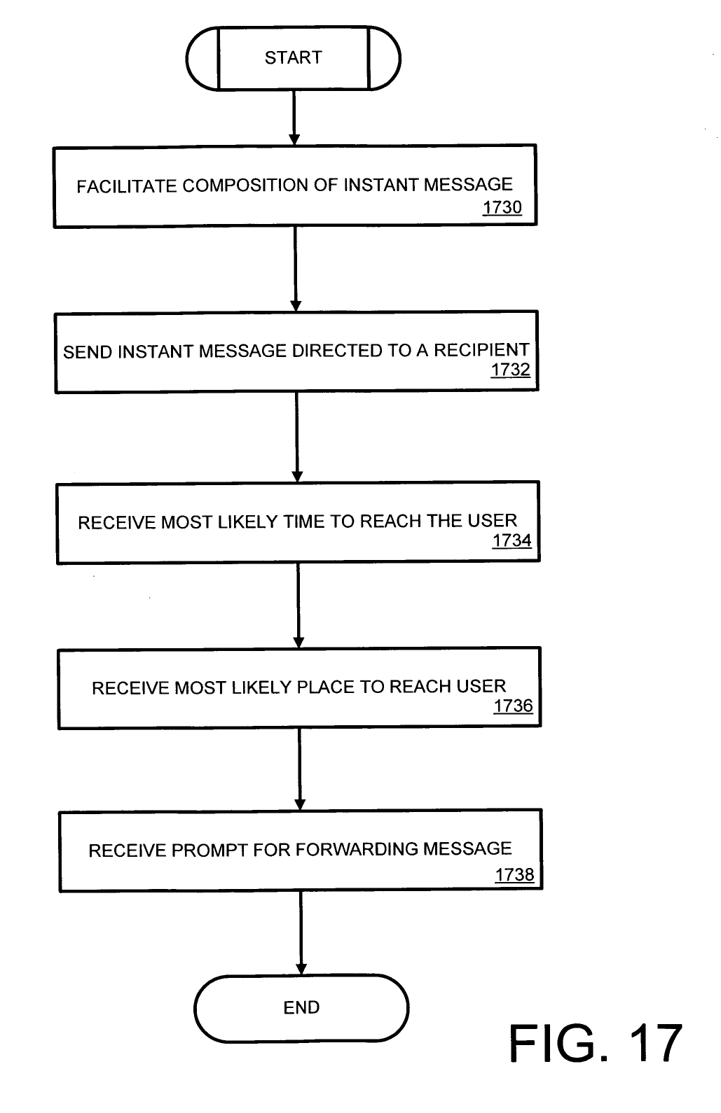

FIG. 17 is a flowchart illustrating exemplary steps that a message sender's instant messaging client software can perform when sending a message, as shown in FIG. 11.

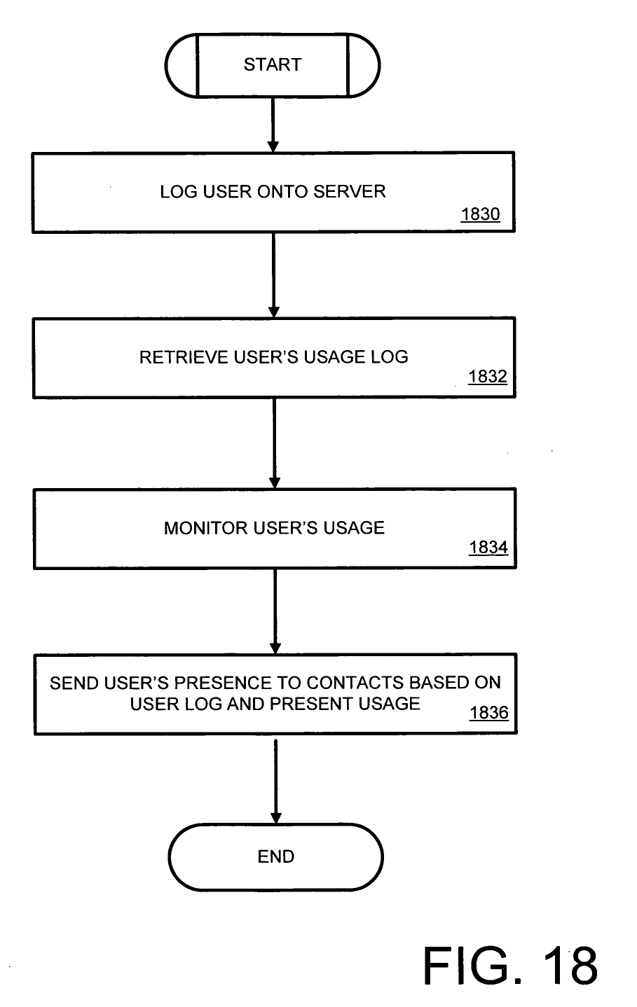

FIG. 18 is a flowchart illustrating exemplary steps that can be taken in sending presence data in an instant messaging environment, such as the instant messaging environment from FIG. 1.

### DETAILED DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a functional diagram of an exemplary instant messaging network environment. As illustrated, a plurality of users may be connected via an external network such as Internet 100 or other communications network. The users may access the Internet 100 via client devices 106a (via wireless access point 108a), 106b (via wireless access point 108b), 106c, and 106d. The client devices may include, for example, portable communication devices 106a and 106b, a local network 106c and/or a personal computer 106d. It should be appreciated that the external network, client devices and connections illustrated in FIG. 1 are shown by way of example, but this disclosure is not limited to these examples. The disclosure may be applicable to any client device, connection, and external network that supports instant messaging. Additionally included in this nonlimiting example is a server 102 that is coupled to a data storage unit 104.

During an instant messaging session, a user may activate instant messaging client software that is stored on the user's client device 106a. Activation of the instant messaging client software can facilitate a connection request with the server 102, which may be a dedicated instant messaging server. The server 102 can then authenticate the user via any of a number of authentication techniques including, but not limited to technologies related to a user identification (userid) and password (userpw) and various biometric authentication processes. According to an exemplary embodiment, the authentication process includes the server receiving data (such as a userid and userpw) and comparing that data with data stored on data storage 104 (data storage logic, database, or authentication server). If the data submitted by the user matches the data stored in data storage 104, the user can be authenticated, and granted access to instant messaging services.

Once the user has been authenticated, the user can send an instant message to any of his or her contacts (e.g., other parties that communicate with the user). According to an exemplary embodiment, the user can send an instant message to anyone who has an account with the server 102. If the user knows the desired recipient's account name, handle, or instant message identification (IMID) associated with the server 102, the user can send an instant message to that recipient. Additionally, in many circumstances, the user will have the user's contacts saved on instant messaging client software or on the server 102 such that the user does not have to know and re-enter the account name each time the user wishes to send an instant message.

Additionally, the server 102 can keep track of the various users that are currently logged onto the server, and provide presence information regarding the user's contacts. Thus, if a user wishes to send an instant message to a recipient, the server 102 can send information as to whether that contact is currently logged onto the server. Upon receiving presence data related to the user's contacts, the user can then send an instant message to a recipient (whose presence is known), thereby beginning an instant messaging chat session. While the server 102 can monitor presence data for each user associated with the server 102, other implementations can provide that logic on user device 106 determines the user's presence. The user's client device 106 can then communicate this data to the server 102 for transmission to other users.

In at least one instant messaging environment, each message sent between the user and the contact can be communicated through the server 102. In such a scenario, the user at client device 106a can compose and send an instant message that is directed from the user's client device 106a to the wireless access point 108a, and then to the Internet 100. The message can then be sent to the server 102 back through the Internet 100 to the recipient's client device 106b. Other embodiments can provide that the server initiate a communication between users, however once the communication is established, the server is removed from the communication such that the users can communicate directly.

Additionally, while some instant messaging environments have a dedicated instant messaging server (or servers), others may use general purpose devices of varying capabilities to manage instant messaging traffic as well as perform other tasks. Further, while this nonlimiting example discusses a proprietary instant messaging environment, one should note that this disclosure also contemplates an environment utilizing a universal instant messaging protocol, or a communications environment that facilitates communication across a plurality of different instant messaging services using a plurality of different instant messaging protocols.

FIG. 2 is a functional diagram of an exemplary local network environment by which a user can send an instant message, similar to the environment from FIG. 1. The local network environment of FIG. 2 can be a home network, a business network or other network configured to facilitate communication between users. As illustrated, client devices 106e, 106f, 106g are coupled to a local router 210. This coupling may be wire-line or wireless. Though depicted as personal computers, the client devices 106e, 106f, and 106g may be implemented with any device capable of supporting instant messaging in a local network. The local router is coupled to local server 202a and local server 202b. Although two local servers 202a and 202b are shown for illustrative purposes, it will be appreciated that more or fewer than two local servers may be used. The local servers 202a, 202b (collectively referred to as local server 202) are coupled to local data storage 204. The local servers 202 are also coupled to an external network, such as the Internet 100.

In this exemplary networking environment a user located at client device 106e may desire to send an instant message to a recipient located at client device 106g. In the networking environment of FIG. 2, the user at client device 106e can compose and send the instant message via client software stored on the client device 106e. The message can then be sent from the client device 106e to the local router 210. The local router can then send the message to one of the local servers 202. The local server 202 can communicate the message back through the local router 210 to the intended recipient located at client device 106g.

As the nonlimiting example of FIG. 2 illustrates, in some embodiments instant messages can be sent internal to the local network, without the use of an external network, such as the Internet 100. As stated above, such a configuration may be desirable for a business that wishes to facilitate communication between employees, but not to the Internet community at large. Such a configuration may use its own instant messaging protocol, a universal instant messaging protocol, or a proprietary instant messaging protocol.

Additionally, while the configuration of FIG. 2 facilitates intra-network instant messaging, this configuration can also facilitate inter-network instant messaging, similar to the configuration from FIG. 1. In such a scenario, a user operating client device 106f can send and receive messages to a contact that is not located within the local network of FIG. 2. The message can be sent through local router 210 to local server 202. From local server 202, the message can be sent to an external network, such as the Internet 100.

Referring back to FIG. 1, the message can then be sent from the network 106c to server 102 (which is not part of the local network in FIG. 2), and then back through the Internet 100 to client device 106b. The contact that is operating client device 106b can then reply through the same channels. More specifically, the reply message can be sent from 106b through the Internet 100 to the server 102, back through the Internet 100, to the network 106c (to FIG. 2), to the local server 202, through the local router 210, and back to the user at client device 106f.

One should note that the configuration of FIG. 2 is a nonlimiting example. Components can be added or removed (or both) without diverging from the scope of this disclosure. Additionally, although the configurations from FIGS. 1 and 2 are illustrated as various examples of instant messaging configuration, these are not meant to be limiting. More specifically, in at least one configuration, instant messages sent between unrelated users need not use the Internet 100. Two users that are engaged in an instant messaging chat session on the same Internet Service Provider (ISP) may not require the use of the Internet 100 to facilitate the communication. As the ISP can link a user to the Internet 100, two users operating on the same ISP may simply use the ISP to facilitate the communication. In such a scenario, the configuration of FIG. 2 becomes more applicable, even for users who are not otherwise related. Additionally, if a company has multiple offices, use of the Internet 100 for instant messaging communications may be desired, and may be implemented similar to the configuration of FIG. 1.

FIG. 3 is a functional diagram illustrating an exemplary embodiment of a client device that may be configured to communicate via a communications network such as the networks from FIGS. 1 and 2. Although a wire-line client device is illustrated, this discussion can be applied to any device. Generally, in terms of hardware architecture, as shown in FIG. 3, the client device 106 includes a processor 382, volatile and nonvolatile memory 384, a display interface 394, data storage 395, and one or more input and/or output (I/O) device interface(s) 396 that are communicatively coupled via a local interface 392. The local interface 392 can include, for example but not limited to, one or more buses or other wired or wireless connections. The local interface 392 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 382 can be a hardware device for executing software, particularly software stored in volatile and nonvolatile memory 384.

The processor 382 can be any custom made or commercially available processor, a central processing unit (CPU), an auxiliary processor among several processors associated with the client device 106, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80×86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 384 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 384 may incorporate electronic, magnetic, optical, and/or other types of storage media. Note that the volatile and nonvolatile memory 384 can have a distributed architecture, where various components are situated remote from one another, but can be accessed by the processor 382.

The software in volatile and nonvolatile memory 384 may include one or more separate programs, each of which includes an ordered listing of executable instructions for implementing logical functions. In the example of FIG. 3, the software in the volatile and nonvolatile memory 384 may include instant messaging client software 399, as well as an operating system 386. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system 386 can control the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 384, so as to operate properly in connection with the Operating System 386.

The Input/Output devices that may be coupled to system I/O Interface(s) 396 may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 106 is a personal computer, workstation, or the like, the software in the volatile and nonvolatile memory 384 may further include a basic input output system (BIOS) (omitted for simplicity). The BIOS is a set of software routines that initialize and test hardware at startup, start the Operating System 386, and support the transfer of data among the hardware devices. The BIOS is stored in ROM so that the BIOS can be executed when the client device 106 is activated.

When the client device 106 is in operation, the processor 382 is configured to execute software stored within the volatile and nonvolatile memory 384, to communicate data to and from the volatile and nonvolatile memory 384, and to generally control operations of the client device 106 pursuant to the software. Software in memory, in whole or in part, is read by the processor 382, perhaps buffered within the processor 382, and then executed.

FIG. 4 is an illustration of an exemplary display for the instant messaging client software discussed with reference to FIGS. 1 and 2. As illustrated, the desktop display 470 can include a “START” button 472, an “INSTANT MESSAGING” taskbar menu item 474, an “EMAIL” taskbar menu item 476, an “INTERNET” taskbar menu item 478, and a Date and Time indicator 480. As one of ordinary skill in the art will understand, the taskbar menu items can be linked to various software programs that are currently open on the client device 106. As a nonlimiting example, the instant messaging client software 399, which can be configured to display a user interface, similar to instant messaging window 482, relates to the taskbar menu item 474. By selecting the “INSTANT MESSAGING” taskbar menu item 474, the user can display and remove the instant messaging window 482 from the desktop display 470.

As illustrated, the instant messaging window 482 includes a text prompt 484 for the user to enter a message. The input box 484 can be configured to display both outgoing messages and incoming messages. As such, a history (thread) of the current instant messaging session can be documented. The contact can be selected by the checkbox next to each contact in the contact section 486 of the instant messaging window 482. Additionally in contact section 486 is a presence icon associated with each contact. As discussed above, the server 102 can determine which users are currently logged onto the server and can display this information to contacts of that user. In this nonlimiting example, the contacts “Leigh,” “Rebecca,” and “Louise” are currently logged onto the server 102, while “Andrew” is not logged onto the server.

Additionally included in the instant messaging window 482 are a “PRESENCE” button 494, an “OPTIONS . . . ” button 488, a “LOGS . . . ” button 490, and a “SEND” button. The “PRESENCE” button 494 can provide the user with the ability to determine presence settings, as discussed below. The “OPTIONS . . . ” button 488 can provide the user access to various options related to the display of the instant messaging window 482, sending options, receiving options, presence options, etc. The “LOGS . . . ” button, on the other hand can provide the user with data related to previously monitored instant messaging usage. The “SEND” button is an action button that executes sending of a message to the recipient or recipients.

One should note that the instant messaging client software 399, which can be configured to display the user interface of FIG. 4 is included for purposes of illustration, not limitation. As is evident to one of ordinary skill in the art, any instant messaging logic can be used to facilitate communication of instant messages between a user and a recipient.

FIG. 5 is an illustration of an exemplary display for the instant messaging client software that can be displayed in response to selecting an option from FIG. 4. As illustrated, Logs display 582 includes a plurality of options for usage logs related to the user's instant messaging usage. A usage log can include data related to the time that a user is using the instant messaging software 399, the instant messaging server 102, or both. In some embodiments, a usage log can document the times that a user accesses the instant messaging server 102. This information can be used to determine various patterns in the user's instant messaging usage. The information can then be used to determine presence, as well as other information that can be provided to the user's contacts. Additionally, the logs can document more detailed information while logged onto the instant messaging server 102. More specifically, the information such as response time to received messages, inactivity periods (both with respect to the instant messaging software and the user device as a whole), and the particular device that the user uses to access the instant messaging server 102. Other information can also be documented for providing more accurate and precise presence data to a user's contacts. Additional examples of documented data can include response statistics, scheduled appointments, response patterns during scheduled appointments, etc.

Included in the Logs window 582 are options for determining how the data in the usage logs are implemented. More specifically data compilation option 588 provides the user with the option for creating a log for each day individually, creating a log for workdays and non-workdays, and creating a log for all days together. More specifically, this option allows a user to differentiate between workdays and non-workdays, or treat each day separately (i.e., the data collected on Mondays does not affect the data collected for Tuesdays). This option can be beneficial for the varying schedules that users may have. As a nonlimiting example, a first user who works from Monday to Friday can have a different instant messaging availability on Saturday and Sunday. Additionally, a second user who works Monday, Wednesday, and Saturday can have a different instant messaging schedule than the first user. This option provides both users the ability to customize their individual schedules for the data logs.

Another option provided in the Logs window 582 is the “KEEP DATA” option 590, which can provide the user with an option to select a desired amount of time that data is kept in a log. If a user feels that his or her schedule regularly changes, the user can keep data in the logs for only a short amount of time. This can allow the changes to have a greater impact in a shorter amount of time. Alternatively, if a user has a fairly rigid schedule and does not want day to day scheduling anomalies to affect the user's schedule, the user can select an option that maintains data in the data log for a greater period of time.

While the two options described below are illustrated in FIG. 5, as one of ordinary skill in the art will understand, other options can also be available. As a nonlimiting example, the user can be provided with an option to determine which of the user's contacts are provided with this usage data. If a user only wants certain people to have access to this data, the user can indicate which data is provided to which contacts. Other embodiments can include options for individually selecting for each log the amount of time that data is kept.

Additionally, one should note that while this disclosure discusses creating a single log, one or more logs can be created for a user. More specifically, separate logs can be created for each day of the week. Additionally, separate logs can be created based on the different types of data being compiled. More specifically, a log can be created based on user activity when logged on to the instant messaging server 102. Another log can be created to document times and durations of chat sessions. Yet another log can be created for response time to reply to messages, one for response time to reply to messages during scheduled appointments, one for response time to reply to messages during scheduled events with a particular keyword included (such as “dentist appointment”). As one of ordinary skill in the art will understand, other logs can also be created. One should also note that while multiple data logs may be created, these data logs can be linked, combined, or otherwise manipulated to determine various presence data about the user.

Included in logs window 582 are a plurality of exemplary options by which a user can manage his or her usage logs. More specifically, logs window 582 includes an “EDIT LOGS” option 592a, a “CLEAR LOGS” option 592b, and a “VIEW LOGS” option 592c. With respect to the “EDIT LOGS” option, if a user's usage log indicates that the best time to reach a user is at 2:00 PM, any weekday, but this may no longer be correct. In such a situation, the user can manually change this data to more accurately represent the user's current availability. Additionally, if certain entries in the usage log are anomalies in the user's normal schedule, the user can change or remove these entries to more accurately represent the correct data. As a nonlimiting example, if the usage logs indicate that the best time to reach the user is at 8:00 PM, via his mobile telephone's instant messaging client, but the user has since discontinued service for the mobile phone, the user can remove the data related to this usage.

The next option displayed in Logs window 582 is the “CLEAR LOGS” option 592b. This option allows the user to clear any or all of the data in any of the logs associated with the user's instant messaging usage. Similar to the “EDIT LOGS” option 592a, the “CLEAR LOGS” option 592b can be implemented by the user to remove unwanted data from the usage logs. While the “CLEAR LOGS” option 592b can be incorporated into the “EDIT LOGS” option 592a, this is not a requirement, as these can be separate options, as shown in FIG. 5.

An additional option illustrated in FIG. 5 is the “VIEW LOGS” option 592c. Similar to the “EDIT LOGS” option 592a and the “CLEAR LOGS” option 592b, the “VIEW LOGS” option 592c can provide the user an option to view data related to the user's instant messaging usage. However, the “VIEW LOGS” option 592c can provide the user this data without the concern of inadvertently modifying the data. Additionally, the data displayed in the “VIEW LOGS” option 592c can be presented in a more “user friendly” configuration such that the user can more easily understand the data being displayed.

FIG. 6 is an illustration of an exemplary display for the instant messaging client software that can be displayed in response to selecting an option from FIG. 5. Designation window 682 can be displayed as a result of a user input related to the “VIEW LOGS” option 592c, the “EDIT LOGS” option 592a, or the “CLEAR LOGS” option 592b (or any combination thereof). To view, edit or clear a log, the user can be presented with designation window 682, which can include any of a plurality of options for determining which logs are selected. More specifically, the user can determine which account the user wishes to view, modify, or clear, as shown in the select account option 684. In the nonlimiting example of FIG. 6, the user has a home instant messaging account, a work instant messaging account, and a mobile phone account (which may have telephonic services, email, instant messaging, etc). Additionally, the user can choose to view an overall usage, which is an option to view the combined usage of all the above listed accounts. One should note that any combination of the above listed accounts can be displayed by selecting any or all of the accounts shown.

Additionally illustrated in determination window 682 is a select log option 686, which can provide the user with an option to view the account (or accounts) selected in option 684 as a text log, a line graph, or a bar graph (or any combination of these). A time frame option 688 may also be included, which can provide the user with the ability to determine the time frame by which to view the log (or logs). While dates can be entered to display a certain period of time, the time frame option 688 can also be configured to receive an “all” command, which can provide the user with all of the stored data related to the selected account or accounts. After the user has selected the desired options, the user can select the “VIEW LOG” option 690. One should note that while the above-described display includes these options, other options can also be available to provide a user a more comprehensive and concise presentation of usage data.

FIG. 7 is an illustration of an exemplary display for the instant messaging client software that can be displayed in response to selecting the view logs option from FIG. 6. As illustrated in IM log display 782, usage log 788 can include various data related to the user's activity on the instant messaging server 102. Additionally included in this nonlimiting example is a “REMOVE” option 792, which can allow a user to remove any of the entries in the usage log 788. In operation, the user can select one or more of the entries in the usage log 788, and by selecting the “REMOVE” option 792, the user can remove the entry from the usage log. Additionally included in the IM log display 782 is a “CLEAR ALL” option 790, which can allow the user to clear all entries in the usage log 788.

FIG. 8 is an illustration of an exemplary display for the instant messaging client software that can be displayed in response to selecting the view logs option from FIG. 6. As illustrated in the detailed IM log window 882, data similar to the data in FIG. 7 is displayed. An indication of logon and log off time are included, as well as times when the user was logged on, but the user was “idle.” While “idle” status can occur when the user's client device 106 receives no inputs (e.g., keyboard or mouse activity) for a predetermined amount of time, this is not a requirement. In at least one nonlimiting example, “idle” can include a condition where the user is active on the client device 106, but the instant messaging window is inactive. Other embodiments of an “idle” state include situations where the user's response time to replying to received instant messages exceeds a predetermined threshold. Still other embodiments include receiving input from a proximity device that is coupled to client device 106 that indicates that the user is not present in the proximity of the client device 106.

Additionally while the above-described IM log window 882 includes only an “idle” status, other embodiments can also include various presence states including “inactive,” “busy,” “extended away,” “out to lunch,” or any standard or user defined presence state. By including this type of detail to the usage log, even more accurate descriptions of the user's presence can be communicated to the user's contacts.

FIG. 9 is an illustration of an exemplary display for the instant messaging client software that can be displayed in response to selecting the view logs option from FIG. 6. As illustrated in the work IM line graph window 982, data from the usage log of FIGS. 7 and 8 can be displayed. Depending on the particular configuration, the line graph 994 can display overall availability (as illustrated in FIG. 9) or the line graph 994 can display each component of availability (such as away, busy, inactive, etc.) that is measured.

The line graph 994 of FIG. 9 includes “availability %” as the vertical axis 990. This scale can range from 0 to 100% and can be linear or logarithmic. In the nonlimiting example of FIG. 9, the availability % is a linear scale in 25% increments. The horizontal axis of line graph 994 includes a time of day scale ranging from 8:00 AM to 12:00 PM. As stated above, this data can be an average workday, non-workday, an average Monday, an average day in general, etc. Other embodiments can display this information as an entire day (12:00 a.m.-12:00 a.m.) of instant messaging usage. As illustrated in the nonlimiting example or FIG. 9, the line graph 994 displays average usage of the user's instant messaging account over a plurality of days. Line graph 994 illustrates that the best times of day to reach the user is around 9:45 AM, 10:45 AM, 11:00 AM, and 11:45 AM. Between 9:00 AM and 9:05 AM, the user will generally not be available.

While the data displayed in FIGS. 7, 8, and 9 illustrate previous data that has been compiled about a user, this data can be applied to determine future availability of the user. As a nonlimiting example, if a contact attempts to send the user an instant message at the user's work instant messaging account at 9:03 AM, the instant messaging software 399 (or instant messaging server 102) can communicate information to the contact that the user is not available at this time, but that the user will likely return in about five minutes. While this determination can be made exclusively from the data compiled in the data log 788, 888, this is not intended to be a requirement. Other embodiments can include applying the historical data in the data log 788, 888 in conjunction with a response delay that exceeds a predetermined amount of time. Still other embodiments can use compiled data logs when the user's client device is currently idle. As one of ordinary skill in the art will realize, these settings can be set by the user, an instant messaging administrator, or both.

FIG. 10 is an illustration of an exemplary display for the instant messaging client software that can be displayed in response to selecting the presence option from FIG. 5. As illustrated in the presence window 1082, the user is provided with the ability to create a new presence based on various criteria. As a nonlimiting example, if the compiled data logs indicate that a user is not present between 9:00 AM and 9:05 AM, the user can designate that this particular time be associated with a presence indicator of “Away—daily meeting,” or other user defined presence indicator.

Similarly, the user can designate that whenever the usage log indicates that the user is present, a predetermined percentage of time, the user can designate a user created presence status. As a nonlimiting example, a user selects the <5% option from the use when present option 1096, and can designate this presence status to be “Probably not here, try me at home.” Additionally, the user can designate whether to enable a contact suggestion option 1098, which can provide a contact with a suggestion as to where the user may be currently located.

Another option displayed in FIG. 10 is a message forward option 1092. The message forward option 1092 can forward a received instant message to the user when the user receives a message in the designated presence status. The user can designate where the instant message is to be forwarded, and in what format the user desires to receive the forwarded instant message (these options not shown). As a nonlimiting example, if the user activates the option to forward messages received when in “Probably not here try me at home” status, the user can also designate that the message is forwarded to the user's home email account. The user can designate that the instant message be attached to an email message. Other embodiments provide that the user can designate that the message be received as an instant message, as a Short Message Service (SMS) text message, as an email message, as a text-to-voice converted voice message, or other type of message (or any permutation of these).

FIG. 11 is an illustration of an exemplary display for the instant messaging client software that can be displayed to a contact in an instant messaging environment, such as the instant messaging environments of FIGS. 1 and 2. As illustrated in IM window 1182, the contact's instant messaging software can provide a display similar to the user's instant messaging software. More specifically, the contact's instant messaging software can include a text prompt 1184, a “PRESENCE” option 1188, an “OPTIONS . . . ” option 1190, a “LOGS . . . ” option 1192, and a “SEND” option 1194. Similarly, presence indicators 1186 can be provided regarding presence data of the contact's contacts.

Additionally included in this nonlimiting example is a user-defined presence indicator 1196. As illustrated, the user has defined that any contact addressing an instant message to the user's work instant messaging account, during a predefined time (or defined by predetermined criteria, as discussed above) be presented with this information. While the contact is composing an instant message, the contact can be provided with this presence indicator 1196. Additionally, a user defined presence icon can be displayed, as discussed in U.S. application Ser. No. ______, entitled “Customizable Presence Icons for Instant Messaging” filed on Dec. 15, 2005 with attorney docket number 190255-1390 (50276), which is hereby incorporated by reference in its entirety.

FIG. 12 is an illustration of an exemplary display for the instant messaging client software that can be displayed to a contact in response to sending an instant message to a user, as discussed with reference to FIG. 11. As illustrated in indicator window 1282, upon sending an instant message to a recipient, the contact can receive an indication that the user is not available, and an expected time for return. This information may be displayed as an instant message text, or as text in a separate message window, such as in text area 1292 in indicator window 1282. Additionally, the contact can be informed of the best place or manner to reach the user, as indicated in text area 1290. Other embodiments can include an indication to the contact that the instant message is being forwarded to the user at another location.

One should note that the text area 1290 and the presence indicator 1196 may or may not convey similar information. As a nonlimiting example, the user can designate that the presence indicator display “On the Golf Course, Be Back Later.” However, the user (to whom the contact is sending a message) may wish that the text area 1290 only indicate that the user will be back in four hours (or at a certain time), and to try again later. Additionally, as discussed above, the user can designate that only certain information is disclosed to certain contacts. As a nonlimiting example, the user may desire the contact of FIG. 12 receive only the data specified in the text area 1290, which indicates that the user will be back in four hours (or at a certain time), and to try again later. The user may not wish to convey the presence information indicated in presence indicator 1196 to this particular contact.

Additionally, the user can specify that the message received from the contact is forwarded to a predetermined account or address related to the user. If the user desires to implement this forwarding option, the user can also designate whether the user wishes to provide to the contact information regarding whether the message is being forwarded. If the user desires that the contact be provided with this information, the indicator window 1282 can be used to facilitate communication of this data. The statistics and log information as described above may be stored in a networked, non-client location, such as a central server so that a response message as illustrated in FIG. 12 can be generated, regardless of the presence of the user.

FIG. 13 is a flowchart illustrating exemplary steps for creating a log, such as the instant messaging usage log from FIG. 8. As illustrated, the first step in the flowchart of FIG. 13 is to log the user onto the instant messaging server 102 (block 1330). In at least one embodiment, the user can open instant messaging software 399 that is located on the user's client device 106. The opening process can begin with the user “double clicking” a desktop icon associated with the instant messaging software 399, or otherwise actively starting execution of the software code. In other embodiments, the instant messaging software 399 can be configured to begin upon startup of the client device 106.

Once the instant messaging software 399 begins execution, the instant messaging software 399 can begin communication with the instant messaging server 102. The instant messaging server 102 can require the user to authenticate himself or herself before granting access to data and services associated with the instant messaging server 102. The authentication process can include the user entering a USERID and password. Another authentication process can include the user storing a USERID and password on the client device, such that upon activation of the instant messaging client software 399, the USERID and password are automatically communicated to the instant messaging server 102. Still another authentication process can include biometric authentication. Biometric authentication can include a fingerprint, retinal scan, voice recognition, or other forms of authentication. Additionally, the biometric authentication can occur at the client device 106, such that the client device authenticates the user, and upon authentication, the user's USERID and password can then be communicated to the instant messaging server 102. Other embodiments include that the biometric authentication be performed on the instant messaging server (or separate authentication server) such that biometric data is communicated to the instant messaging server 102 for comparison with biometric authentication data stored at the instant messaging server 102 site.

Once the instant messaging client software 399 logs the user onto the instant messaging server 102, the instant messaging client software 399 begins creating a data log 788, 888 (block 1332) and can monitor the user's instant messaging usage (block 1334). As discussed above, the data log 788, 888 can include the date and time that the user logs onto the server as well as other information. Additional information can also be included in the data log 788, 888, such as idle time with respect to the instant messaging client software 399, idle time with respect to the client device 106, response time to received messages, physical proximity to the client device, the user's presence on other devices or with other accounts, etc. In addition to the data that can be complied for the user's instant messaging usage, the instant messaging client software 399 can also create graphs, statistics, predictions, etc. based on the compiled usage data.

Next, the instant messaging client software 399 can log the user off of the instant messaging server 102 (block 1336). This step can be completed upon receiving input related to closing or terminating execution of the instant messaging client software 399, input related to shutting down the client device 106, input to “log off” the instant messaging server (without closing the instant messaging client software 399), etc. Upon logging the user off the instant messaging server 102, the next step in this nonlimiting example is to end the data log (block 1338). In some embodiments, this step can be performed by simply including a date and time stamp on the data log indicating that the user has logged off the instant messaging server 102. Additionally, the instant messaging client software 399 can store the updated log (block 1340).

One should note that although the description with regard to FIG. 13 is directed to actions that the instant messaging client software 399 can perform, any or all of these actions can be performed by the instant messaging server 102. As a nonlimiting example, once the user is logged onto the instant messaging server 102, the instant messaging server 102 can begin monitoring the user's instant messaging usage, as described above. While some of the data can be compiled by the instant messaging server 102 directly, other information can be communicated to the instant messaging server via the instant messaging client software 399. Additionally, while the instant messaging client software 399 can store the updated data log (block 1340) in nonvolatile memory 384, in some embodiments the instant messaging server 102 can store this data in a volatile or nonvolatile memory component 384 associated with the instant messaging server, which may or may not include data storage 104. One should additionally note that in some embodiments both the instant messaging server 102 and the instant messaging client software 399 perform at least one of the steps described above. As a nonlimiting example, both the instant messaging client software 399 and the instant messaging server 102 can store the usage log, as described in block 1340.

FIG. 14 is a flowchart illustrating exemplary steps that can be performed by a server in applying a data log, such as the data log from FIG. 8. As illustrated, the first step in the flowchart of FIG. 14 is for the instant messaging server 102 to receive an instant message directed for a user (block 1430). Generally speaking, prior to receiving an instant message directed for the user, the instant messaging server 102 will have logged both the user and the sender of the received message onto the instant messaging server 102. Once this occurs, the instant messaging server 102 can facilitate a communication between the parties (or between any parties currently logged onto the instant messaging server 102).

Once the instant message is received, the instant messaging server 102 can determine the user's presence status (block 1432). While the instant messaging server 102 can constantly or periodically monitor the user's current presence, block 1432 can refer to using information related to historical data compiled regarding the user's past usage patterns or the user's current presence (or both). More specifically, the instant messaging server 102 can determine whether the user is likely to be available to respond to the received message. This determination can be made based on various data compiled, such as historical idle times, historical response times, access to the user's calendar, etc. As a nonlimiting example, if the user receives a message at 4:38 PM, and the user's computer usually becomes idle between 4:40 PM and 4:50 PM, the instant messaging server 102 can determine that the user will likely not respond until at least 4:50 PM.

As an additional nonlimiting example, if the user's calendar has an appointment scheduled to begin at 4:40 PM, and scheduled to end at 5:30 PM, the instant messaging server 102 can determine, based on the compiled historical data and the scheduled event, that the user will not be able to respond until at least 5:30 PM. Additionally, the instant messaging server 102 can also keep track of instant messaging in the wake of scheduled appointments, as well as specific events based on a keyword comparison. With this functionality, the instant messaging server 102 can provide the sender with an indication of response time, etc. based on how the user responded to received messages during other scheduled appointments. In this nonlimiting example, the user can have an event entitled “Dentist Appointment” stored in a calendar. If historical data indicates that during other events with this title, the user has not participated in any instant messaging activities, the instant messaging server 102 can determine that during this “Dentist Appointment” the user will also be fully unavailable. However, if the user has a historical pattern of participating in instant messaging services during a “Dentist Appointment,” the instant messaging server can determine (and communicate to the sender) that the user is in an appointment, but may still be available.

If the instant messaging server 102 determines that the user is present, the instant messaging server 102 can deliver the message (block 1434). If, however, the instant messaging server determines that the user is not present, the instant messaging server 102 can determine when the user will likely return (block 1436), based on historical data, discussed above. Next, the instant messaging server 102 can determine where the user is currently reachable (block 1438), or if the user is currently reachable, and can deliver the message to the user (block 1440). Additionally, based on the information determined in blocks 1436 and 1438, the instant messaging server 102 can provide indication to the sender (block 1442).

One should note that in addition to the steps described in FIG. 14, other embodiments can include steps that provide the sender an option to deliver the message, based on the information received in block 1440. As a nonlimiting example, a sender can send the user an instant message that says “Do you want to play golf at 4:00 today?” Upon receipt of information indicating that the user is currently on the golf course, the sender may determine that the instant message is a moot point, and may wish to not send the message. The sender can then revoke the message before the message is sent.

FIG. 15 is a flowchart illustrating exemplary steps that can be performed by client logic in applying a data log, such as the data log from FIG. 8. As illustrated, the first step of FIG. 15 is for the instant messaging client software to receive an instant message from an instant messaging server 102 (block 1530). As before, the instant messaging server 102 can authenticate the user and a contact such that the user and the contact can communicate in an instant messaging chat session. After the parties are logged onto the server, the user's instant messaging client software 399 can receive a presence request from the contact's client device 106, via the instant messaging server 102, as described in block 1530.

Upon receipt of the message, the instant messaging client software 1532 can determine if the user is present based on historical usage data. As discussed above, the instant messaging client software 399 can be configured to compile and analyze a plurality of data regarding the user's schedule and instant messaging usage. If the instant messaging client software 399 determines that the user is present, the message can simply be displayed to the user (block 1534). If, on the other hand, the instant messaging client software 399 determines that the user is not present, the instant messaging client software 399 can determine when the user will likely be available to receive the message (block 1536). As stated above, the instant messaging client software 399 can be configured to analyze compiled usage data regarding the user. Additionally, the instant messaging client software 399 can retrieve other data related to the user's availability, such as appointments on an electronic calendar (either via the Internet or a calendar stored on the client device 106).

Additionally, process shown in the flowchart of FIG. 15 can determine where the user is likely to be reachable (block 1538). As stated above, the instant messaging client software 399 can be configured to determine, based on historical and other data to determine where (or if) the user is currently available. As a nonlimiting example, if the instant messaging client software 399 determines that the user typically sends and receives communications at this time on the user's mobile telephone, the instant messaging client software can communicate this information to the instant messaging server 106 and the information may be relayed to the message sender. Finally, the instant messaging client software 399 can display the message to the user (block 1540).

FIG. 16 is a flowchart illustrating exemplary steps that a message sender's instant messaging client software can perform when sending a message, as shown in FIG. 11. As illustrated, the first step in FIG. 16 is to facilitate composition of an instant message (block 1630). Next, the sender's instant messaging client software 399 can be configured to send an instant message directed to the recipient (block 1632). After sending the message, the sender's instant messaging client software 399 can receive the recipient's instant messaging data log 788, 888 (block 1636). While in some embodiments the entire data log 788, 888 can be communicated to the message sender, other embodiments can be configured to communicate only a portion of the data log 788, 888 that is applicable to the present message. Once the data log 788, 888 is received by the sender's instant messaging client software 399, a determination can be made as to the best time to reach the recipient (block 1636). Additionally, the instant messaging client software 399 can determine the most likely place or address to reach the user (block 1638).

FIG. 17 is a flowchart illustrating exemplary steps that a message sender's instant messaging client software can perform when sending a message, as shown in FIG. 11. As illustrated, the first step in the flowchart of FIG. 17 is to facilitate composition of an instant message (block 1730). Similar to the nonlimiting example of FIG. 16, the flowchart of FIG. 17 is viewed from the perspective of the instant messaging client software 399 for an instant messaging sender. The instant messaging client software 399 can facilitate composition of an instant message by providing a user interface to input text, pictures, video, and other data, such as the user interface from FIG. 11. The next step in this nonlimiting example is to send an instant message directed to a recipient (block 1732). The instant message can be sent to an instant messaging server 102, or directly to the recipient, as discussed above. Next, the instant messaging client software 399 can receive data related to the most likely time to reach the recipient (block 1734). Additionally, the instant messaging client software 399 can receive data related to the most likely place to reach the recipient (block 1736), as discussed above. While the nonlimiting example of FIG. 16 includes receiving the data log from the recipient's client software, this nonlimiting example includes receiving the desired data. One should note that some embodiments may be configured to receive this information from an instant messaging server 102, and other embodiments may be configured to receive this information directly from the recipient's client device 106. The next step of FIG. 17 is to prompt the user to forward the message to another destination, based on the received data (block 1738). As a nonlimiting example, if the sender receives data that the recipient is most likely to be found on the recipient's mobile telephone, the sender can be prompted as to whether the sender wishes to forward the message to that device (or account). Additional options for the sender can be to continue original delivery, continue original delivery and forward the message, only forward the message, or send no messages, among others.

FIG. 18 is a flowchart illustrating exemplary steps that can be taken in sending presence data in an instant messaging environment, such as the instant messaging environment from FIG. 1. As illustrated, the first step of FIG. 18 is to log a user onto the instant messaging server (block 1830). Next, the instant messaging client software 399 can retrieve the user's data log 788, 888 (block 1832). The data log 788, 888 can be located in volatile and nonvolatile memory 384 on the user's client device 106, however this is not a requirement. In some embodiments the data log 788, 888 can be located on a different client device 106, a server, in data logic, or at another locale. The information can be accessible via the Internet or other external network, via a local network, or a combination of the two.

Once the usage log is retrieved, the instant messaging client software 399 can monitor the user's instant messaging usage (block 1834). In monitoring the user's instant messaging usage, the instant messaging client software 399 can determine various patterns in the user's instant messaging usage, and can make predictions based on these patterns. The next step is to display the user's presence to contacts based on the data log 788, 888 and the present usage. While the nonlimiting examples described above include providing this information to an instant message sender upon receipt of an instant message, this nonlimiting example includes providing this information to the user's contacts without the need of sending an instant message. As a nonlimiting example, the user's presence can be included on a status bar before a message is sent. Other embodiments can include providing the desired information when the user “hovers” or selects the contact's account name or presence icon.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should also note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums. Further, as indicated above, other embodiments can provide that the usage log and other data can be stored on a networked server 102, at data storage 104, or locally on the client device 106 (or any permutation of these and other networked elements). Additionally, the logic described herein (which can be implemented in software, hardware, etc.) can be located or accessible by a networked server 102, data storage 104, or client device 106.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for collecting data for determining the presence of an instant messaging user, comprising:
receiving data related to instant messaging activity of the user; and
creating at least one data log, the at least one data log including data related to the instant messaging activity of the user for use in determining presence information of the instant messaging user.

2. The method of claim 1, further comprising determining, from the data log, at least one statistic related to the availability of the user.

3. The method of claim 1, further comprising:
receiving a communication request from a sender;
retrieving at least a portion of the at least one data log; and
sending an indication related to instant messaging availability of the user based on the data log.

4. The method of claim 3, wherein sending an indication related to availability of the user includes sending information related to a time that the user is expected to be available.

5. The method of claim 3, wherein sending an indication related to availability of the user includes sending information related to a network address that the user is expected to be currently available.

6. The method of claim 3, further comprising forwarding the received message to a second client device associated with the user, in response to a determination that the user is currently unavailable at the first client device.

7. A computer readable medium having a program for collecting data for determining the presence of an instant messaging user, the program comprising:
logic configured to receive data related to instant messaging activity of the user; and
logic configured to create at least one data log, the at least one data log including data related to the instant messaging activity of the user for use in determining presence information of the instant messaging user.

8. The computer readable medium of claim 7, the program further comprising logic configured to determine, from the data log, at least one statistic related to the availability of the user.

9. The computer readable medium of claim 7, the program further comprising:
logic configured to receive a communication request from a sender;
logic configured to retrieve at least a portion of the at least one data log; and
logic configured to send an indication related to instant messaging availability of the user based on the data log.

10. The computer readable medium of claim 7, wherein logic configured to send an indication related to availability of the user includes logic configured to send information related to a time that the user is expected to be available.

11. The computer readable medium of claim 7, wherein logic configured to send an indication related to availability of the user includes logic configured to send information related to a network address that the user is expected to be currently available.

12. The computer readable medium of claim 7, further comprising logic configured to forward the received message to a second client device associated with the user, in response to a determination that the user is currently unavailable at the first client device.

13. A method for sending presence data about a user to an instant messaging sender, the method comprising:
receiving a communication request from the sender;
in response to a determination that the user is not available for communication, predicting likely availability of the user based on an analysis of presence data related the user, wherein the presence data includes data related to historical instant messaging usage of the user; and
sending a communication to the sender indicating a time that the user is likely to be available.

14. The method of claim 13, further comprising:
retrieving a data log, wherein the data log includes historical data associated with instant messaging usage of the user; and
calculating a likelihood of user presence based on the data log.

15. The method of claim 13, wherein sending at least a portion of the presence data related to the user includes sending a probable time of availability for the user.

16. The method of claim 13, wherein sending at least a portion of the presence data related to the user includes sending a probable network address of current availability for the user.

17. The method of claim 13, further comprising sending a user-defined indicator of presence status to the sender.

18. The method of claim 13, further comprising:
receiving an instant message directed for the user, from the sender;
determining, based on the historical instant messaging data, that the user is unavailable at a first client device; and
in response to determining that the user is unavailable at the first client device, forwarding the received instant message to a second client device.
